(19) United States
(12) Patent Application Publication
(10) Pub. No.: US 2026/0143065 A1
(43) Pub. Date: May 21, 2026

(54) ELECTRONIC DEVICE THAT INDICATES CURRENT INTEREST IN RECEIVING TELEPHONE CALL BASED ON REGISTERED PRIOR ACTIVITY

(71) Applicant: MOTOROLA MOBILITY LLC, WILMINGTON, DE (US)

(72) Inventors: AMIT KUMAR AGRAWAL, BANGALORE (IN); VIJAYPRAKASH IDLUR, BANGALORE (IN); PANDURANGA REDDY PAILLA, NALGONDA (IN)

(21) Appl. No.: 18/948,916

(22) Filed: Nov. 15, 2024

(51) Int. Cl. H04M 3/436; H04M 3/42

(52) U.S. Cl. CPC H04M 3/4365; H04M 3/42042; H04M 3/42059

(57) ABSTRACT

An electronic device provides techniques for filtering unwanted call requests while anticipating user interest in receiving call requests from particular unknown callers that should be presented for acceptance by the user. In response to receiving a telephone call from a telephone number not included in a contact of a personal knowledge base, a processor is configured to cause the electronic device to determine whether at least one registered prior activity by a user of the electronic device indicates that the user has a current interest in receiving the telephone call from a second party associated with the first telephone number. In response to determining the user has current interest, the processor is configured to cause the electronic device to generate and present via output device(s) an indication of the current interest, along with at least one call session control enabling the user to accept or decline the telephone call.

### BACKGROUND

### 1. Technical Field

The present disclosure relates generally to electronic devices that receive telephone calls, and more particularly to electronic devices that display information and receive telephone calls.

### 2. Description of the Related Art

Electronic communication devices such as smartphones enable users to receive incoming communication requests to establish video or voice communication sessions with one or more second electronic devices. While these devices provide a useful function for inter-person communication, the communication devices are susceptible to receiving unsolicited cold calls that are considered spam or junk calls. As one tool provided to help a user to avoid these unwanted calls, communication systems generally support caller identification (ID). Users often ignore calls received from a caller having a caller ID that the user does not recognize. Electronic devices increasingly identify spam and junk calls based on the caller ID being unavailable or not included in contacts stored at the electronic device. As another tool, call alerts may be presented in a non-intrusive manner when the call is deemed spam or junk. In an example, a size of a visual alert may be reduced and not accompanied by an audio and vibration alert.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to be advantageously implemented, according to one or more embodiments;

FIG. 1B is an additional block diagram representation of the electronic device of FIG. 1A presenting additional components, including components for wireless communications with other devices, according to one or more embodiments;

FIG. 2 is an example communication environment with the electronic device handling unknown voice/video call requests from three second electronic devices based on determined user interest, according to one or more embodiments;

FIG. 3 illustrates a voice/video call interface window including call handling controls presented on a display of the electronic device, in response to determined user interest, according to one or more embodiments;

FIGS. 4A-4B (collectively “FIG. 4”) are a flow diagram presenting a computer-implement method for presenting acceptance options for a call request from an unknown caller, in response to determining current user interest based on registered prior activity of communicating with or receiving information from an entity/service associated with the unknown caller, according to one or more embodiments; and

FIG. 5 is a flow diagram presenting a computer-implemented method augmenting the method of FIG. 4 by determining expiration of the current user interest based on passage of time or a concluding event, according to one or more embodiments.

### DETAILED DESCRIPTION

According to aspects of the present disclosure, an electronic device, a method and a computer program provide various techniques for filtering unwanted call requests while anticipating user interest in particular unknown caller requests that should be presented for acceptance by the user. Currently, some available electronic devices enable call filtering by requiring that full visual, vibratory, and/or audio call alerts are only presented when the caller is identified or when the caller is included in a contact saved on the electronic device. When a call is received that originates from suspected spam or junk callers, whose calling phone numbers are not in a contact, a less intrusive call alert may be presented, such as a small visual alert that may be easily overlooked. Although reducing or avoiding spam and junk callers, in certain instances, calls that are important to the user may be missed, especially if the caller's number is not recognized. In an example, a user may be interested in purchasing property and enter a query to a real estate company. A realtor responding to the query with a phone call from an office number may utilize a number that is previously unknown to the user and thus not in an established contact stored in electronic device of the user. The user may lose an opportunity to buy the property if the call is missed. In another example, the user may be in the market for purchasing life, property, or vehicle insurance. The user may enter user contact information into a brokerage website that distributes the contact information along with the specific insurance parameters that the user is seeking. One or more insurance representatives that are previously unknown to the user may respond but may have their calls blocked as potentially spam. In an additional example, the user may have expressed a problem of finding someone to repair an appliance or home system. In an example, the user may have sent an email, text message, application direct, message or other communication to someone or searched online. By word of mouth or just by coincidence, someone who provides the same goods or services may attempt to call the user. In situations such as this where there is a mutual interest, missing the calls due to spam/junk filters creates frustration and inconvenience to the user and the caller.

The embodiments disclosed herein address and overcomes the aforementioned issues/problems/limitations by identifying prior user interactions that indicate that the user is pursuing information related to the unknown caller. To enable the user to quickly decide whether or not to accept the call request, the electronic device presents information showing/explaining the basis for determining the anticipated user interest. The user is thus able to avoid missing a call of current importance while still being assisted in blocking unknown callers that are not of current interest to the user.

According to one or more embodiments, an electronic device includes at least one input device and at least one output device. The electronic device includes a memory having a personal knowledge base containing at least one contact, each having at least one associated telephone number that is cleared for originating received telephonic communication. The electronic device includes a communications subsystem that links the electronic device to a communication network that supports telephonic communication sessions. A processor of the electronic device is communicatively coupled to the at least one input device, the at least one output device, the memory, and the communications subsystem. In response to receiving a telephone call from a first telephone number that is not included in a contact of the personal knowledge base, the processor is configured to cause the electronic device to determine whether is at least one registered prior activity by a user of the electronic device that indicates that the user has a current interest in receiving the telephone call from a second party associated with the first telephone number. In response to determining the user has the current interest, the processor is configured to cause the electronic device to generate and present via the at least one output device an indication of the current interest, along with at least one call session control enabling the user to accept or decline the telephone call.

According to one or more embodiments, a method is provided for filtering unwanted call requests while anticipating user interest in particular unknown caller requests that should be presented. The method includes maintaining a memory having a personal knowledge base containing at least one contact, each contact having at least one associated telephone number that is cleared for originating received telephonic communication. The method includes linking, via a communications subsystem of an electronic device, to a communication network that supports telephonic communication sessions. In response to receiving a telephone call from a first telephone number that is not included in a contact of the personal knowledge base, the method includes determining whether at least one registered prior activity by a user of the electronic device indicates that the user has a current interest in receiving the telephone call from a second party associated with the first telephone number. In response to determining the user has the current interest, the method includes generating and presenting, via the at least one output device, an indication of the current interest, along with at least one call session control enabling the user to accept or decline the telephone call.

Further embodiments provide a computer program product that includes: a non-transitory computer readable medium; and program code on the computer readable medium that, when processed by a processor of an electronic device, configures the processor and/or the electronic device to perform functions of the above-described method.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent within the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized, and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

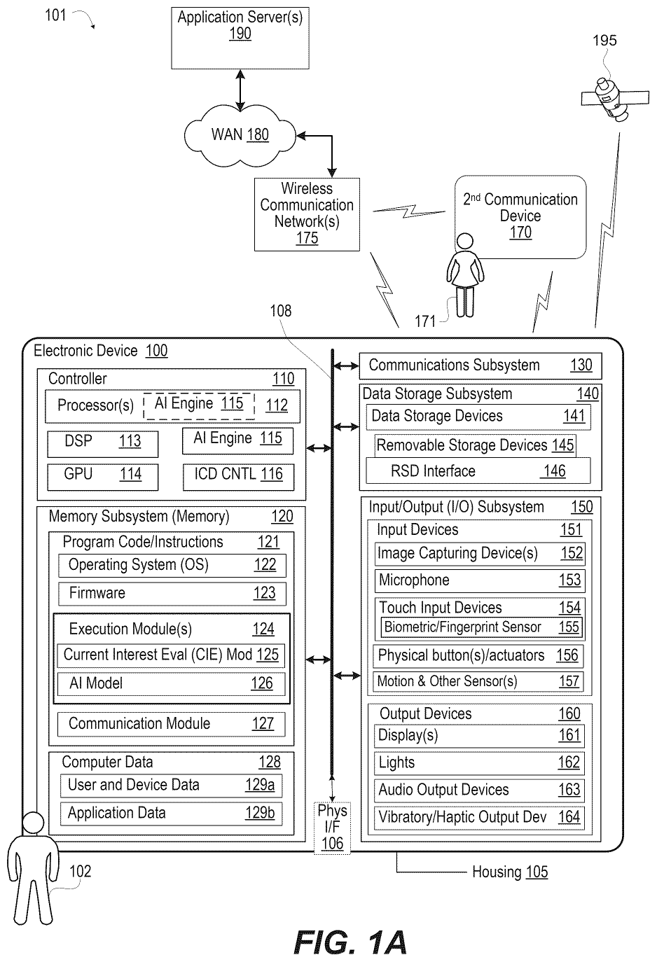

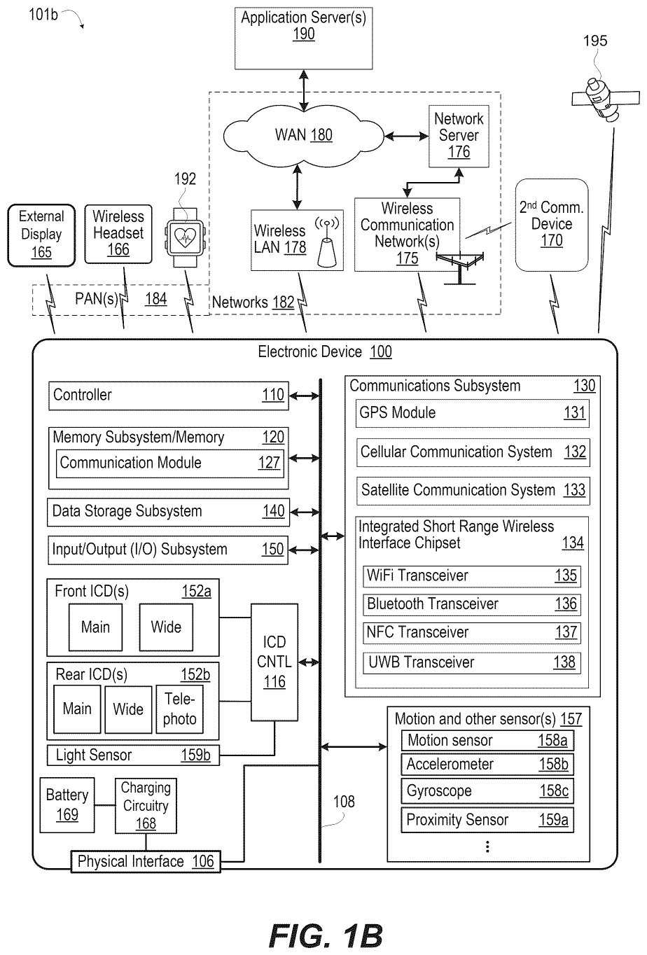

Those of ordinary skill in the art will appreciate that the hardware components and basic configuration depicted in the following figures may vary. For example, the illustrative components within electronic device 100 (FIG. 1A-1B) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural, functional, operational, or otherwise) on the described embodiments.

Referring now to the figures and beginning with FIG. 1A, there is illustrated a block diagram of an example electronic device 100 in a communication environment 101 and having hardware and software components, which enable the features of the present disclosure to be advantageously implemented, according to one or more embodiments. Examples of electronic device 100 can include, but are not limited to, mobile devices, a notebook computer, a mobile phone, a smart phone, a digital camera with enhanced processing capabilities, a smart watch, a tablet computer, and other types of electronic devices. For purposes of this disclosure, electronic device is assumed to be a communication device that can be used to engage in a voice and/or video call with a second communication device. Electronic device 100 can therefore be interchangeably referred to herein as communication device 100.

Electronic device 100 generally includes controller 110, memory (or memory subsystem) 120, communication subsystem 130, data storage subsystem 140, input/output subsystem 150, all contained within or extended from an exterior surface of device housing 105. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice-versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more of operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113, graphics processing units (GPUs) 114, artificial intelligence (AI) engine 115, and image capturing device (ICD) controller 116. In some embodiments, the functionality of each of these additional processing components can be integrated with processor(s) 112. For example, processor 112 can, in some embodiments, include dedicated AI engine 115 and image signal processors (ISPs) (not shown). Processor 112 can further include other processors such as auxiliary processor(s) that may act as a low power consumption, always-on sensor hub for physical sensors.

Controller 110 manages, and in some instances directly controls, the various functions and/or operations of electronic device 100. These functions and/or operations include, but are not limited to including, application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122.

Memory subsystem (or memory) 120 may include a combination of volatile and non-volatile memory, such as random-access memory (RAM) and read-only memory (ROM). Memory subsystem 120 stores instruction or program code 121 for execution by processor 112 to configure processor 112 (and more generally electronic device 100) to provide the operational functions and features described herein. Instructions/program code 121 (or program code 121 for short) includes instructions for an operating system (OS) 122, firmware 123, such as basic input/output system (BIOS) or Uniform Extensible Firmware Interface (UEFI). Program code 121 includes execution module(s) 124 that collectively provides the various features of the disclosure. Execution module(s) 124 include, without limitation, current interest evaluation (CIE) module 125, which provides the features and operating functionality of the disclosed embodiments when the corresponding program instructions of CIE module 125 are processed by/within processor 112/controller 110.

Execution modules 124 further includes AI model(s) 126. In one or more embodiments, processor 112 can utilize AI models 126 to provide AI functionality of processor-integrated AI engines 115. In other embodiments, AI models 126 are directly utilized by AI engine 115. In one or more embodiments, AI model 126 is integrated as a sub-module within CIE module 125 and is trained to support the AI features of CIE module 125. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identifying the underlying features performed by processing the different modules. For example, CIE module 125 can include program instructions that cause or configure processor 112 to cause electronic device 100 to determine whether prior activities by a user of the electronic device indicate a current interest in a receiving a call from a caller that would otherwise be presented as a spam or junk caller. Other features provided by CIE module 125 are described in further detail throughout this disclosure.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at electronic device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 170 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc.

Data storage subsystem 140 of electronic device 100 can include removable storage device(s) (RSD(s)) 145, which is received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of CIE module 125 and AI model(s) 126, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152, microphone 153, and touch input devices 154 (e.g., touch screens, keys, or buttons) for use by user 102 to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user. In some embodiments, the biometric sensor 155 can supplement an ICD (camera), which captures images for user detection/identification via facial recognition.

Input devices 151 may include physical buttons/actuators 156 that can be located on a periphery of the device housing 105. Physical buttons/actuators 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description which.

With reference to FIG. 1B, as illustrated, motion and other sensor(s) 157 of electronic device 100 include, but are not limited to, one or more motion sensor(s) 158a, one or more accelerometers 158b, one or more gyroscopes 158c, and proximity sensor 159a, etc. Motion sensor(s) 158a detect movement of electronic device 100 and provide motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. Proximity sensor 159a senses the presence of nearby objects. In one embodiment, proximity sensor 159a can be an infrared (IR) sensor that detects the presence of a nearby object, such as when electronic device 100 is in a pocket of a user. Electronic device 100 can also include one or more light sensors 159b, which detects the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive user's tactile/touch input. As a touch screen device, integrated display 161 allows a user to provide input to and/or to control electronic device 100 by touching features within a user interface presented on integrated display 161. Tactile, touch screen interface (154) can be utilized as an input device. The touch screen interface (154) can include one or more virtual buttons or selectable affordances. In one or more embodiments, when a user applies a finger or stylus on the touch screen interface (154) in the region demarked by the virtual button, the touch of the region causes the processor 112 to execute code to implement a function associated with the virtual button. In some implementations, integrated display 161 is integrated into a front surface of electronic device housing 105 along with front image capturing devices (not specifically shown), while the higher quality ICDs are located on a rear surface of device housing 105. Other embodiments provide multiple integrated displays within electronic device 100, and references to display(s) 161 are assumed to refer to one or all of these multiple integrated displays.

Vibration/haptic output device 164 can cause electronic device 100 to vibrate or shake when activated. Vibration/haptic output device 164 can be activated during an incoming call or message in order to provide an alert or notification to a user of electronic device 100. In one or more embodiments, integrated display 161, audio output devices (or speakers) 163, and vibration/haptic device 164 can generally and collectively be referred to as output devices.

With reference again to FIG. 1B and with continuing reference to FIG. 1A, there is presented another view of electronic device 100 with components enabling electronic device 100 to function as a mobile communication device, within an expanded communication environment 101b. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101b that includes other devices.

Communications subsystem 130 includes global positioning system (GPS) module 131 that enables electronic device to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem includes cellular communication system 132, which includes at least one radio frequency RF front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to engage in long distance wireless communication capabilities.

In one or more embodiments, communications subsystem 130 includes integrated short range wireless interface chipset 134 having one or more of Wi-Fi transceiver (TxRX) 135, Bluetooth (BT) TxRx 136, near field communication (NFC) transceiver 137, and ultra-wideband (UWB) transceiver 138. In one or more embodiments, the short-range communication devices are not integrated on a single chipset but can be separately provided hardware components. In one or more embodiments, electronic device 100 can communicate wirelessly with external wireless devices, such as a WiFi router of a wireless local area network (WLAN) 178 and/or second electronic device 170, via one or more short-range wireless interface(s). Second electronic device 170 can be a communication device, such as a smartphone, and/or can be similarly configured as electronic device 100. Second user 171 may operate second electronic device 170. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can provide a downloadable version of CIE module 125 and/or access to other applications, online transactions, and resources. In one or more embodiments, networks 182 can also include personal area networks (PAN) 184, which are individually created with second devices via one of short-range wireless devices from among Wi-Fi TxRX 135, BT TxRx 136, NFC transceiver 137, and UWB transceiver 138. Example second devices include external display 165, wireless headset 166, and wearable computing device 192. External display 165 can be a stand-alone monitor/display or a display integrated into a second electronic device, such as a laptop computer. In at least one embodiment, connection to the external display 165 can be wired and can include an intermediate connection device, such as a docking station device. In one or more embodiments, wearable computing device 192, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 106. Physical interface 106 of electronic device 100 can serve as an input/output data port and can be used as a power supply port that is coupled to charging circuitry 168 which feeds electrical power to device battery 169 to enable recharging of device battery 169 and/or powering of electronic device 100. As a data port, physical interface 106 can enable electronic device 100 to be physically coupled via a cable or docking station port to a second device, such as external display 165.

FIG. 1B also presents additional details of ICD(s) 152 of electronic device 100. Throughout the disclosure, the term image capturing device (ICD) is synonymous with and/or utilized interchangeably with any one of the cameras of electronic device 100. ICD(s) (or cameras) 152 includes front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152a can include a main camera and a wide-angle camera. Rear ICD(s) can include a main camera, a wide-angle camera, and a telephoto camera. Both sets of cameras 152 include image sensors that can capture images that are within the field of view (FOV) of each respective camera 152. In one or more embodiments, one or more of the cameras can be utilized to enable biometric authentication using facial image or iris scan recognition.

In the description of each of the following figures, reference is also made to specific components illustrated within the preceding figure(s). Similar or same components are presented with the same leading reference number.

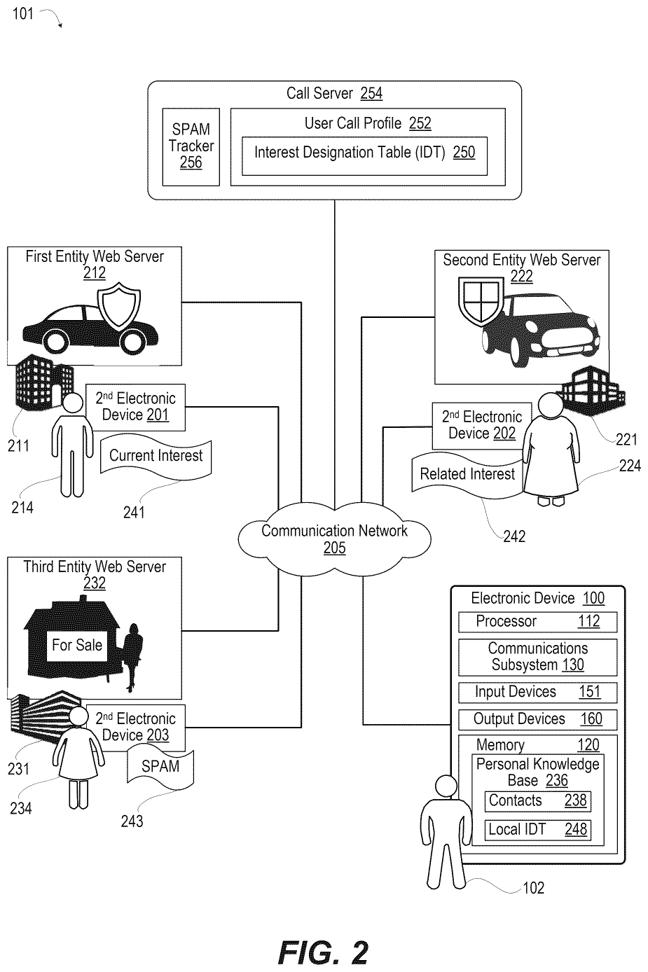

FIG. 2 is example communication environment 101 with electronic device 100 sequentially handling unknown telephonic voice/video call requests from three second electronic devices 201, 202, and 203 based on determined user interest of user 102, respectively. For clarity, electronic device 100 is communicatively connectable to second electronic devices 201-203 via communication network 205 that may include wired and wireless links as described above. Communication network 205 supports telephonic call sessions with caller ID such as via a wireless wide area network (WWAN), cellular communication network, and a plain old telephone system (POTS). In an example, first entity 211 (e.g., business, product, service, institution, organization, institute, etc.) may be associated with first entity web server 212, which is connected to communication network 205. First entity 211 advertises goods and services such as automobile insurance and provides opportunities for requesting additional information via a telephone call. First caller 214 is an employee or agent of first entity 211 and is a user of second electronic device 201, which can be used to make telephone calls. A telephone number assigned to second electronic device 201 may be one of a plurality of telephone numbers associated with first entity 211.

Second entity 221 (e.g., business, product, service, institution, organization, institute, etc.) may be associated with second entity web server 222, which is connected to communication network 205. Second entity 221 advertises goods and services such as automobile insurance and provides opportunities for requesting additional information via a telephone call. Second caller 224 is an employee or agent of second entity 221 and is a user of second electronic device 202, which can be used to make telephone calls. A telephone number assigned to second electronic device 202 may be one of a plurality of telephone numbers associated with second entity 221.

Third entity 231 (e.g., business, product, service, institution, organization, institute, etc.) may be associated with third entity web server 232, which is connected to communication network 205. Third entity 231 advertises goods and services such as residential home sales and provides opportunities for requesting an additional information via a telephone call. Third caller 234 is an employee or agent of third entity 231 and is a user of second electronic device 203 that can make telephone calls. A telephone number assigned to second electronic device 203 may be one of a plurality of telephone numbers associated with third entity 231.

Electronic device 100 has personal knowledge base (PKB) 236 that contains contacts 238 that do not correspond to second electronic devices 201-203. For clarity, features are generally described as performed by electronic device 100 with the understanding that the certain aspects of the described processes are being performed by processor 112 and AI engine 115 (FIG. 1A) operating on received/detected data. Electronic device 100 detects, e.g., by monitoring communication, patterns, and habits of user, that user 102 has performed actions that indicate current interest in first entity 211, depicted as current interest designation 241. In an example, user 102 of electronic device 100 has submitted a contact request to first entity web server 212. In an example, a website provides a “contact us” entry form that solicits information of the identity of the person making the inquiry and the nature of their interest and inquiry. In an additional example, electronic device 100 has initiated a telephone call to a telephone number associated with first entity 211. In another example, electronic device 100 has transmitted an email to an email account associated with first entity 211.

According to one aspect of the disclosure, processor 112 or AI engine 115 of electronic device 100 may assign a time limit to current interest designation 241, requiring recent evidence of user 102 seeking contact from first entity 211 to maintain the current interest designation 241. Having a time limit on current interest designation 241 may vary depending on a category of goods or service. In an example, a user may have an interest in a particular new appliance, home improvement or vacation destination. The expected duration of investigation for a purchase for each type of goods or service may have a different duration. If the user has not continued to look for and respond to entities associated with this interest in accordance with an expected duration of time, then electronic device 100 can treat the interest as expired. Electronic device 100 may track the time limit for each current interest designation 241 in local interest designation table (IDT) 248 in memory 120. In one or more embodiments, electronic device 100 may track the time limit for each current interest designation 241 in IDT 250 associated with user call profile 252 in call server 254. Call server 254 may provide crowd sourced Spam policies in Spam tracker 256 for identified and unidentified callers that are unknown to electronic device 100. Unidentified callers do not provide caller ID. Unknown callers are those not having a contact on electronic device 100.

Alternatively, or in addition, electronic device 100 may detect a concluding action that indicates expiration of current interest designation 241. In an example, electronic device 100 may detect a communication record (e.g., short message service (SMS) text, email, application direct message, electronic facsimile, etc.) indicating interest in purchasing or contracting for the particular goods and services. In another example, electronic device 100 may detect an action of user 102 declining a call associated with first entity 211. Based on declining the call, electronic device 100 may determine that the current interest has expired or that the user is no longer interested in the particular entity or service.

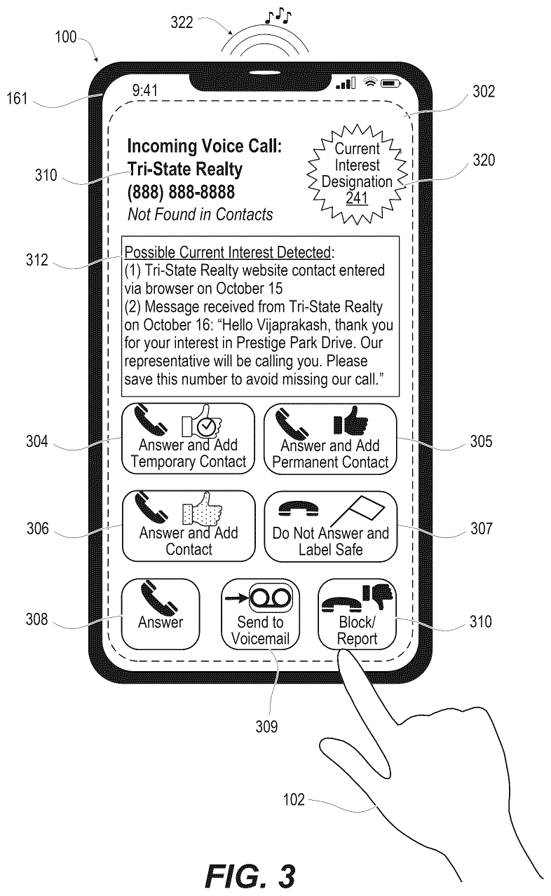

In one or more embodiments, AI engine 115 (FIG. 1A) balances indications as a function of time of current interest over repeated interactions between particular entities (411, 421, and 431) and user 102. Electronic device 100 may provide more than one (e.g., 2 or 3) chances to reject a related call before moving an unknown caller back into an unapproved Spam list, since user 102 may inadvertently report a call as spam or not answer a call before realizing that there is a current interest in the particular entity or the particular type of goods or service. In an example, user 102 may overlook additional information such as present below in the description of FIG. 3 when the call from the unknown caller is initially received.

Electronic device 100 may further associate current interest designation 241 to a type of goods and services, such as procuring automobile insurance. Based on a current interest in procuring a particular type of goods and service, electronic device 100 may assign related interest designation 242 to other entities that provide the same type of goods and services. In an example, second entity 221 may be assigned related interest designation 242. Electronic device 100 may present related interest designation 241 with additional information such as presented below in d the description of FIG. 3.

Electronic device 100 may include features for blocking and attenuating alerts for other potential spam and junk callers based on either local or crowd sourcing policies. In an example, electronic device 100 may identify that there has been no interactions with third entity 231, third entity web server 232, or communications (e.g., telephone calls, emails, messages) associated with third entity 231. In response to receiving a call from second electronic device 203, electronic device 100 may assign spam/junk designation 243 to second electronic device 203, reducing visual, audio, and/or haptic alerts presented at electronic device 100 to avoid an unwanted distraction to user 102.

FIG. 3 illustrates video/voice call interface window 302 including call handling controls 304-308 that are presented on display 161 of electronic device 100, in response to determined user interest. For clarity, features are generally described as performed by electronic device 100 with the understanding that the certain aspects of the described processes are being performed by processor 112 and AI engine 115 (FIG. 1A) operating on received/detected data. In response to determining current interest in a caller, electronic device 100 presents video/voice call interface window 302 in full screen mode, similar to when a call is received from a known caller (i.e., if saved information corresponding to caller ID 310 is found in a contact 238 (FIG. 2)). Conversely, when a detected spam/junk call request is detected, electronic device 100 may present a small popup alert when there is no current interest determined. In an example, electronic device 100 presents an indication of the current interest as interaction summary segment 312 providing a summary or an excerpt from a previous communication record to inform user 102 of the basis of current interest designation 241. Electronic device 100 presents call session controls 304-310 in video/voice call interface window 302, enabling user 102 to accept or decline the telephone call. In an example, first call handling control 304 is labeled “answer and add temporary contact”. User 102 may wish to receive such calls for a limited period of time. Second call handling control 305 is labeled “answer and add permanent contact”. User 102 may wish to handle future calls from that caller ID as a known contact. Third call handling control 306 is labeled “Answer and Add Contact”. User is not required to designate whether temporary or permanent. Fourth call handling control 307 is labeled “Don't Answer and Label Safe”. Spam policies are modified to include the number in a safe list. Fifth call handling control 308 is labeled “Answer”. Sixth call handling control 309 is labeled “send to voicemail”. User 102 may not be currently able to take the call or wish to further screen the incoming call or receive the call information without directly speaking to the caller. Seventh call handling control 310 is labeled “block/report”. In an example, user 102 may only want to talk to a particular entity and want to block all other entities.

With reference again to FIG. 2, according to aspects of the present disclosure, electronic device 100 includes at least one input device 151 and at least one output device 160. Electronic device 100 has memory 120 including personal knowledge base (PKB) 236 containing at least one contact 238, each having at least one associated telephone number that is cleared for originating received telephonic communication (i.e., being a phone number associated with a second device from which a telephonic communication is received). Electronic device 100 includes communications subsystem 130 that links electronic device 100 to communication network 205 that supports telephonic communication sessions. Processor 112 of electronic device 100 is communicatively coupled to memory 120, communications subsystem 130, at least one input device 151, and at least one output device 160. In response to receiving a telephone call from a first telephone number that is not included in contacts 238 in PKB 236, processor 112 is configured to cause electronic device 100 to determine whether at least one registered prior activity (e.g., communication or information request) by user 102 of electronic device indicates that the user has a current interest in receiving the telephone call from a second party associated with the first telephone number. In an example, the second party is first entity 211. In response to determining user has the current interest (e.g., current interest designation 241), processor 112 is configured to cause electronic device 100 to generate and present via at least one output device 160 an indication (e.g., current interest designation 241 and interaction summary segment 312 of FIG. 3) of the current interest, along with at least one call session control 304-308 (FIG. 3) enabling user 102 to accept or decline the telephone call.

In one or more embodiments, in response to determining user 102 does not have a current interest, processor 112 is further configured to cause electronic device 100 to generate and present via least one output device 160 a second indication that the first telephone number is potentially from a source that is not cleared (e.g., spam/junk designation 243), along with at least one call session control 304-308 (FIG. 3) enabling user 102 to accept or decline the telephone call.

In one or more embodiments, processor 112 is further configured to cause electronic device 100 to monitor the at least one registered prior activity including communications and interactions with secondary sources. The monitoring is performed via artificial intelligence (AI) model 126 (FIG. 1A) trained to recognize current interest based on one or more registered prior activity. Processor 112 is further configured to cause electronic device 100 to parse the at least one registered prior activity to identify user interest in at least one particular type of good, service, vendor, or merchant. Processor 112 is further configured to cause electronic device 100 to generate and store an activity record that aligns the user interest with potential categories of callers based at least in part on the at least one particular type identified from parsing the at least one registered prior activity.

In one or more particular embodiments, processor 112 is further configured to cause electronic device 100 to establish a threshold period of time following detection of the at least one registered prior activity within which subsequently received calls from a source related to the indicated user interest can be presented with the indication of current interest. Processor 112 is further configured to cause electronic device 100 to evaluate a time of receiving the telephone call from the first number relative to the threshold period of time. Processor 112 is further configured to cause electronic device 100 to present the indication of current interest in response to the telephone call being received within the threshold period of time.

In one or more particular embodiments, in determining the current interest, processor 112 is further configured to cause electronic device 100 to indirectly associate the at least one registered prior activity to the second party via detected interest in a third party providing a similar service or good. In making this indirect association, processor 112 is further configured to cause electronic device 100 to associate the at least one registered prior activity to the third party (e.g., first entity 211). Processor 112 is further configured to cause electronic device 100 to determine a category of provider of goods or service (e.g., vehicle insurance) associated with the third party (e.g., first entity 211). Processor 112 is further configured to cause electronic device 100 to determine that the second party (e.g., second entity 321) is also associated with the category of provider of the good or service (e.g., vehicle insurance). Thereby, the current interest in the category of provider of good or service (e.g., vehicle insurance) is determined to indicate a current interest in another provider of the same good or service (e.g., second entity 321).

In one or more specific embodiments, the current interest is contingent upon a need for a good or service not yet being fulfilled. In particular, processor 112 is further configured to cause electronic device 100 to search communication records for at least one second registered prior activity that indicates completion of a transaction for the category of good or service (e.g., purchase receipt). The at least one second registered prior activity is subsequent to the at least one registered prior activity that indicated the current interest. In response to determining that a second registered prior activity subsequent to the at least one registered prior activity indicates completion of a transaction for the category of goods or service, processor 112 is further configured to cause electronic device 100 to update the activity record to no longer identify the current interest. In response to subsequently receiving a next telephone call from the first telephone number, processor 112 is further configured to cause electronic device 100 to generate and present via the at least one output device an indication that the first telephone number is potentially spam or a junk call, along with at least one call session control to accept or decline the telephone call. In one or more embodiments, changing status of the current interest may be implemented by creating a temporary phone contact (including the phone number, caller descriptor, or call ID of the expected caller) at the time of the at least one registered prior activity that initially triggered the current interest designation. The phone contact can be stored or maintained in a temporary safe SPAM folder or other location associated with electronic device 100. In one or more embodiments, the temporary storage of the temporary phone contact is contingent upon the need for the good or service still remaining to be fulfilled. Upon identifying the fulfillment of the need based on the at least one second registered prior activity, the temporary phone contact is deleted. A pending call request or a subsequent call request from the deleted phone contact would not be found in a the device's contacts after the deletion of the temporary contact, and thus, the subsequent call requires would be handled as a spam or junk call.

In one or more embodiments, in determining the current interest, processor 112 is further configured to cause electronic device 100 to determine that the first telephone number is associated with one or more telephone numbers registered for use by the second party. In one or more embodiments, the at least one registered prior activity includes one or more types of communication from amongst a group comprising: (i) webpage browsing history; (ii) entering contact information into a webpage; (iii) outbound text message; (iv) inbound and outbound telephone call history; and (v) outbound email.

In one or more embodiments, in generating and presenting the first call session control via the at least one output device, processor 112 is further configured to cause electronic device 100 to generate and present a spam option control (e.g., seventh call handling control 310 of FIG. 3) whose selection overrides the at least one registered prior activity for a subsequently received telephone call. In one or more embodiments, processor 112 is further configured to cause electronic device 100 to identify the current interest using an artificial intelligence (AI) engine training to associate registered prior activities to providers of a category of goods and services. In one or more embodiments, the indication of the current interest includes at least one indication from among a group including: (i) a text notification (e.g., current interest designation 241 of FIG. 3); (ii) a symbol (e.g., 24-point star 320); (iii) a color code; and (iv) special ringtone 322. In an example, video/voice call interface window 302 may include a color associated with a current interest that is different from the normal color of a video/voice call interface window presented for either a known caller or a spam/junk caller.

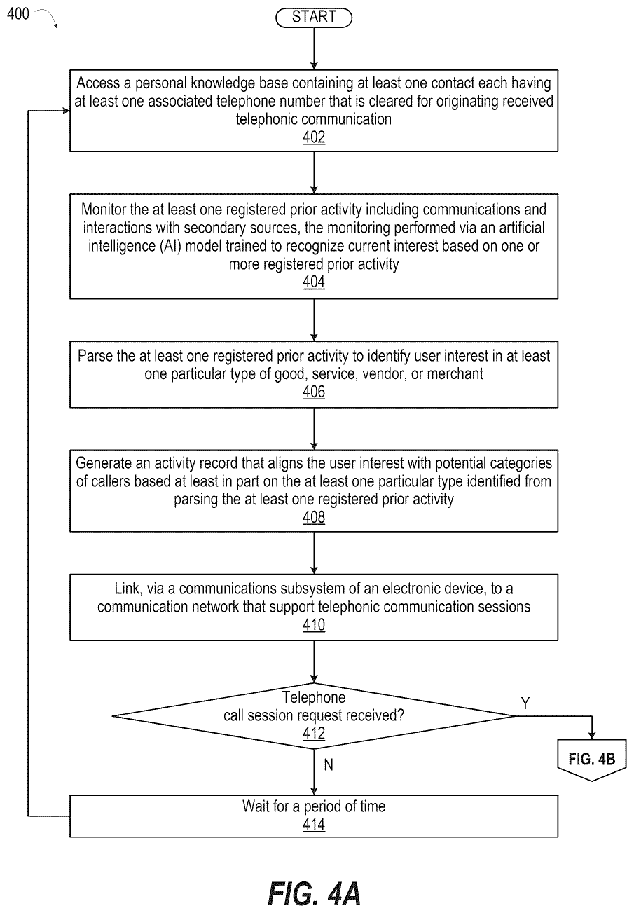

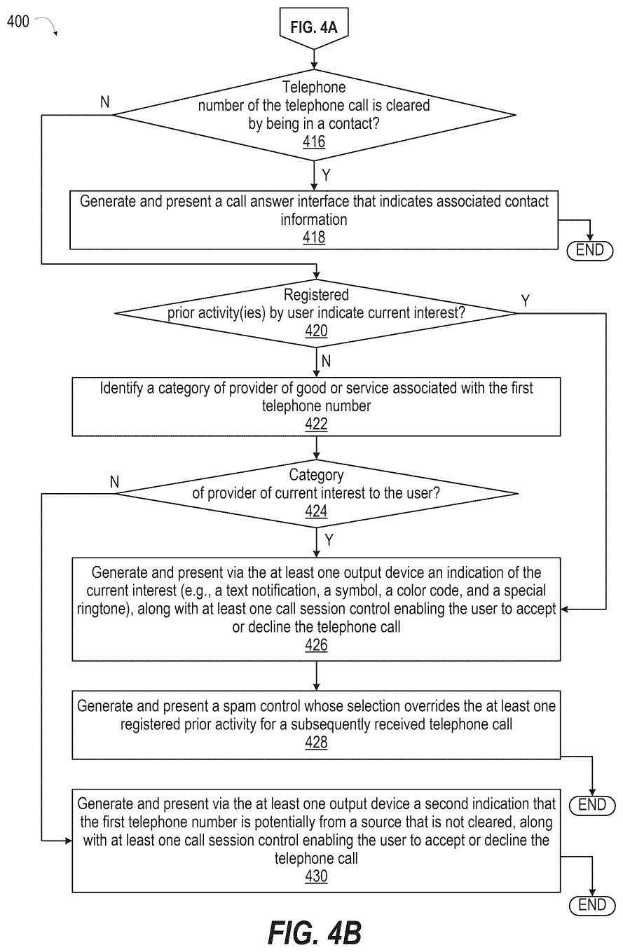

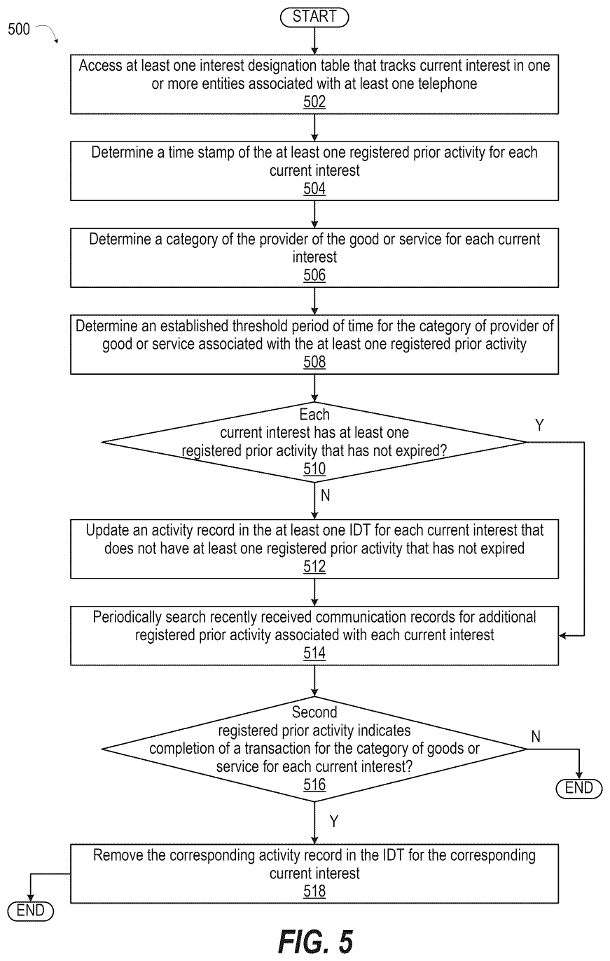

FIGS. 4A-4B (collectively “FIG. 4”) are a flow diagram presenting computer-implement method 400 for presenting acceptance options for a call request from an unknown caller in response to determining current user interest based on registered prior activity of communicating with or receiving information from an entity/service associated with the unknown caller. FIG. 5 is a flow diagram presenting computer-implemented method 500 augmenting method 400 of FIG. 4 by determining expiration of the current user interest based on passage of time or a concluding event. The descriptions of method 400 (FIG. 4) and method 500 (FIG. 5) are provided with general reference to the specific components illustrated within the preceding FIGS. 1-3. Specific components referenced in method 400 (FIG. 4) and method 500 (FIG. 5) may be identical or similar to components of the same name used in describing preceding FIGS. 1-3. In one or more embodiments, controller 110 (FIG. 1A) configures electronic device 100 (FIGS. 1A-1B, 2) or a similar computing device to provide the described functionality of method 400 (FIG. 4) and method 500 (FIG. 5).

With reference to FIG. 4A, method 400 includes accessing a personal knowledge base containing at least one contact each having at least one associated telephone number that is cleared for originating received telephonic communication (block 402). Method 400 includes monitoring at least one registered prior activity including communications and interactions with secondary sources, the monitoring performed via an artificial intelligence (AI) model trained to recognize current interest based on one or more registered prior activity (block 404). In an example, the AI engine training is trained to associate registered prior activities to providers of a category of goods and services. In one or more embodiments, the at least one registered prior activity includes one or more types of communication from amongst a group including: (i) webpage browsing history; (ii) entering contact information into a webpage; (iii) outbound text message; (iv) inbound and outbound telephone call history; and (v) outbound email. Method 400 includes parsing the at least one registered prior activity to identify user interest in at least one particular type of good, service, vendor, or merchant (block 406). Method 400 includes generating an activity record that aligns the user interest with potential categories of callers based at least in part on the at least one particular type identified from parsing the at least one registered prior activity (block 408). Method 400 includes linking, via a communications subsystem of an electronic device, to a communication network that support telephonic communication sessions (block 410). Method 400 includes determining whether a telephone (e.g., video or voice) call session request is received (decision block 412). In response to not receiving a telephone call session request, method 400 includes waiting for a period of time (block 414). Then method 400 returns to block 402 to prepare for receiving a subsequent telephone call session request. In response to determining that a telephone call is received, method 400 includes proceeding to decision block 416 of FIG. 4B, for evaluating and responding to user interest in an unknown caller.

With reference to FIG. 4B, method 400 further includes determining whether a telephone number of the telephone call is cleared for originating received telephonic communications by being included in a device-maintained/stored phone contact (decision block 416). In response to determining that the telephone call is cleared by being included in a phone contact, method 400 includes generating and presenting a call answer interface that indicates associated contact information (block 418). Then method 400 ends. In response to determining that the telephone call is not cleared (i.e., not being included in a contact), method 400 includes determining whether at least one registered prior activity by a user of the electronic device indicates that the user has a current interest in receiving the telephone call from a second party associated with the first telephone number (decision block 420). In response to determining that the user has a current interest in receiving the telephone call from a second party associated with the first telephone number, method 400 includes identifying a category of provider of good or service associated with the first telephone number (block 422). Method 400 includes determining whether the category of provider is of current interest to the user (decision block 424). In response to determining the user has a current interest associated with an owner of the first telephone number in block 420 or in response to determining that the category of provider is of current interest to the user in decision block 424, method 400 includes generating and presenting via the at least one output device an indication of the current interest (e.g., a text notification, a symbol, a color code, and a special ringtone), along with at least one call session control enabling the user to accept or decline the telephone call (block 426). In one or more embodiments, method 400 includes generating and presenting a spam control whose selection overrides the at least one registered prior activity for a subsequently received telephone call (block 428). Then method 400 ends. In response to determining, in decision block 424, that the user does not have a current interest in the category of provider, method 400 includes generating and presenting, via the at least one output device, a second indication that the first telephone number is potentially from a source that is not cleared, along with at least one call session control enabling the user to accept or decline the telephone call (block 430). Then method 400 ends.

With reference to FIG. 5, method 500 may include accessing at least one interest designation table that tracks current interest in one or more entities associated with at least one telephone (block 502). Method 500 may include determining a time stamp of the at least one registered prior activity for each current interest (block 504). Method 500 may include determining a category of the provider of the good or service for each current interest (block 506). Method 500 may include determining an established threshold period of time for the category of provider of good or service associated with the at least one registered prior activity (block 508). Method 500 includes determining whether each current interest has at least one registered prior activity that has not expired (i.e., current time is less than the threshold period of time from a corresponding timestamp) (decision block 510). In response to determining that each current interest does not have at least one registered prior activity that has not expired, method 500 includes updating an activity record in the at least one IDT for each current interest that does not have at least one registered prior activity that has not expired (block 512). In response to determining, in decision block 510 or after block 512, that a current interest has at least one registered prior activity that has not expired, method 500 includes periodically searching recently received communication records for additional registered prior activity associated with each unexpired current interest (block 514). Method 500 includes determining whether a second registered prior activity indicates completion of a transaction for the category of goods or service for the current interest (decision block 516). In response to determining that the second registered prior activity indicates completion of the transaction for the category of goods or services, method 500 includes removing the corresponding activity record in the IDT for the corresponding current interest (block 518). In response to determining that the second registered prior activity does not indicate completion of the transaction for the category of goods or services in decision block 516 or after block 518, method 500 ends.

According to aspects of the present disclosure, the electronic device 100 (FIG. 1A), method 400 (FIG. 4), method 500 (FIG. 5) and computer program product, such as RSD 145 (FIG. 1A), provide techniques for filtering unwanted call requests, while identifying user interest in particular unknown caller requests that should be presented to the user (i.e., not be filtered out or treated as spam). The determination of current interest may be extended to other callers who are associated with a similar or identical type of goods and service. The current interest may be time-limited, based on the passage of time or detection of a closing event, such as purchase of the associated goods and services. Benefits of reducing the inconvenience and aggravation of spam or junk calls are retained while identifying the exceptions for unknown calls that may be important to a user.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms “a”, “an” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

What is claimed is:

1. An electronic device comprising:
at least one input device;
at least one output device;
a memory comprising a personal knowledge base containing at least one contact each having at least one associated telephone number that is cleared for originating received telephonic communication;
a communications subsystem that links the electronic device to a communication network that support telephonic communication sessions; and
a processor communicatively coupled to the at least one input device, the at least one output device, the memory, and the communications subsystem, and which is configured to cause the electronic device to:
in response to receiving a telephone call from a first telephone number that is not included in a contact of the personal knowledge base:
determine whether at least one registered prior activity by a user of the electronic device indicates that the user has a current interest in receiving the telephone call from a second party associated with the first telephone number; and
in response to determining the user has the current interest, generate and present via the at least one output device an indication of the current interest, along with at least one call session control enabling the user to accept or decline the telephone call.

2. The electronic device of claim 1, wherein the processor is further configured to cause the electronic device to:
in response to determining the user does not have a current interest, generate and present via the at least one output device a second indication that the first telephone number is potentially from a source that is not cleared, along with at least one call session control enabling the user to accept or decline the telephone call.

3. The electronic device of claim 1, wherein the processor is further configured to cause the electronic device to:
monitor the at least one registered prior activity comprising communications and interactions with secondary sources, the monitoring performed via an artificial intelligence (AI) model trained to recognize current interest based on one or more registered prior activity;
parse the at least one registered prior activity to identify user interest in at least one particular type of good, service, vendor, or merchant; and
generate an activity record that aligns the user interest with potential categories of callers based at least in part on the at least one particular type identified from parsing the at least one registered prior activity.

4. The electronic device of claim 3, wherein the processor is further configured to cause the electronic device to:
establish a threshold period of time following detection of the at least one registered prior activity within which subsequently received calls from a source related to the indicated user interest can be presented with the indication of current interest;
evaluate a time of receiving the telephone call from the first number relative to the threshold period of time; and
present the indication of current interest in response to the telephone call being received within the threshold period of time.

5. The electronic device of claim 3, wherein, in determining the current interest, the processor is further configured to cause the electronic device to indirectly associate the at least one registered prior activity to the second party via a third party by:
determine a category of provider of goods or service associated with the third party; and
determine that the second party is associated with the category of provider of the good or service.

6. The electronic device of claim 5, wherein the processor is further configured to cause the electronic device to:
in response to determining that a second registered prior activity subsequent to the at least one registered prior activity indicates completion of a transaction for the category of goods or service:
update the activity record to no longer identify the current interest; and
in response to subsequently receiving a next telephone call from the first telephone number, generate and present via the at least one output device an indication that the first telephone number is not included in a contact, along with at least one call session control to accept or decline the telephone call.

7. The electronic device of claim 1, wherein, in determining the current interest, the processor is further configured to cause the electronic device to determine that the first telephone number is associated with one or more telephone numbers registered for use by the second party.

8. The electronic device of claim 1, wherein the at least one registered prior activity comprises one or more types of communication from amongst a group comprising: (i) webpage browsing history; (ii) entering contact information into a webpage; (iii) outbound text message; (iv) inbound and outbound telephone call history; and (v) outbound email.

9. The electronic device of claim 1, wherein, in generating and presenting via the at least one output device the first call session control, the processor is further configured to cause the electronic device to generate and present a spam control whose selection overrides the at least one registered prior activity for a subsequently received telephone call.

10. The electronic device of claim 1, wherein the processor is further configured to cause the electronic device to identify the current interest using an artificial intelligence (AI) engine training to associate registered prior activities to providers of a category of goods and services.

11. The electronic device of claim 1, wherein the indication of the current interest comprises at least one indication from among a group comprising: (i) a text notification; (ii) a symbol; (iii) a color code; and (iv) a special ringtone.

12. A method comprising:
maintaining a memory comprising a personal knowledge base containing at least one contact each having at least one associated telephone number that is cleared for originating received telephonic communication;
linking, via a communications subsystem of an electronic device, to a communication network that support telephonic communication sessions; and
in response to receiving a telephone call from a first telephone number that is not included in a contact of the personal knowledge base:
determining whether at least one registered prior activity by a user of the electronic device indicates that the user has a current interest in receiving the telephone call from a second party associated with the first telephone number; and
in response to determining the user has the current interest, generating and presenting via at least one output device an indication of the current interest, along with at least one call session control enabling the user to accept or decline the telephone call.

13. The method of claim 12, further comprising:
in response to determining the user does not have a current interest, generating and presenting via the at least one output device a second indication that the first telephone number is potentially from a source that is not cleared, along with at least one call session control enabling the user to accept or decline the telephone call.

14. The method of claim 12, further comprising:
monitoring the at least one registered prior activity comprising communications and interactions with secondary sources, the monitoring performed via an artificial intelligence (AI) model trained to recognize current interest based on one or more registered prior activity;
parsing the at least one registered prior activity to identify user interest in at least one particular type of good, service, vendor, or merchant; and
generating an activity record that aligns the user interest with potential categories of callers based at least in part on the at least one particular type identified from parsing the at least one registered prior activity.

15. The method of claim 14, further comprising:
establishing a threshold period of time following detection of the at least one registered prior activity within which subsequently received calls from a source related to the indicated user interest can be presented with the indication of current interest;
evaluating a time of receiving the telephone call from the first number relative to the threshold period of time; and
presenting the indication of current interest in response to the telephone call being received within the threshold period of time.

16. The method of claim 14, wherein determining the current interest further comprises indirectly associating the at least one registered prior activity to the second party via a third party by:
determining a category of provider of goods or service associated with the third party;
determining that the second party is associated with the category of provider of the good or service; and
in response to determining that a second registered prior activity subsequent to the at least one registered prior activity indicates completion of a transaction for the category of goods or service:
updating the activity record to no longer identify the current interest; and
in response to subsequently receiving a next telephone call from the first telephone number, generating and presenting via the at least one output device an indication that the first telephone number is not included in a contact, along with at least one call session control to accept or decline the telephone call.

17. The method of claim 12, wherein:
the at least one registered prior activity comprises one or more types of communication from amongst a group comprising: (i) webpage browsing history; (ii) entering contact information into a webpage; (iii) outbound text message; (iv) inbound and outbound telephone call history; and (v) outbound email; and
the indication of the current interest comprises at least one indication from among a group comprising: (i) a text notification; (ii) a symbol; (iii) a color code; and (iv) a special ringtone.

18. The method of claim 12, wherein generating and presenting via the at least one output device the first call session control comprises generating and presenting a spam control whose selection overrides the at least one registered prior activity for a subsequently received telephone call.

19. The method of claim 12, further comprising identifying the current interest using an artificial intelligence (AI) engine training to associate registered prior activities to providers of a category of goods and services.

20. A computer program product comprising:
a computer readable storage device; and
program code on the computer readable storage device that when executed by a processor associated with an electronic device, the program code is configured to cause the electronic device to provide functionality of:
maintaining a memory comprising a personal knowledge base containing at least one contact each having at least one associated telephone number that is cleared for originating received telephonic communication;
linking, via a communications subsystem of an electronic device, to a communication network that support telephonic communication sessions; and
in response to receiving a telephone call from a first telephone number that is not included in a contact of the personal knowledge base:
determining whether at least one registered prior activity by a user of the electronic device indicates that the user has a current interest in receiving the telephone call from a second party associated with the first telephone number; and
in response to determining the user has the current interest, generating and presenting via at least one output device an indication of the current interest, along with at least one call session control enabling the user to accept or decline the telephone call.
